(19) United States
(12) Patent Application Publication
(10) Pub. No.: US 2005/0049969 A1
(43) Pub. Date: Mar. 3, 2005

(54) Checking account personal identification method

(76) Inventor: Larry J. Kane, Marion, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/829,797

(22) Filed: Apr. 22, 2004

Related U.S. Application Data
(63) Continuation of application No. 60/481,289, filed on Aug. 25, 2003.

(51) Int. Cl. G06F 17/60

(52) U.S. Cl. 705/45

(57) ABSTRACT

This invention is a method of establishing and associating personal identification information to a checking account so that the personal identification information must be entered by the customer, the personal identification information and checking account information transmitted to a remote location for verification, and then a verification message sent from the remote location to the merchant at the point of presentment before the check is accepted by the merchant.

### CROSS REFERENCE TO RELATED APPLICATIONS

This application claims the benefit of U.S. Provisional Application No. 60/481,298, filed Aug. 25, 2003.

### BACKGROUND OF THE INVENTION

The present invention relates to document verification systems and more particularly to a method of associating a Personal Identification Number (PIN) with a checking account so that the PIN must be entered by the customer and validated by the merchant at the time of presentment of the check.

Currently, over 65 billion checks are written each year. Even with the advancement of the credit card, debit card, and other plastic based products, the check continues to be the most favored payment instrument. As with other payment instruments, the check, while the most popular, is plagued with its share of fraudulent usage. In fact, with the increased availability of low cost, high quality printers and computers, the opportunity for fraudsters to create high quality bogus checks is more prevalent than ever.

The majority of the fraud losses occur as a result of a “walk up” transaction, where the perpetrator can secure goods or cash quickly and easily, in exchange for the fraudulent instrument. In this “walk up” transaction, a cashier may ask to see the perpetrator's identification (ID), however, personal identification cards can be easily stolen or forged, not to mention the fact that cashiers generally do not look closely at the customer's identification. In this “walk up” transaction, the offender may be gone before it becomes known that the check is worthless, and the offender's true identity may not ever be known. Therefore, in order to stop the fraud losses, it is imperative to have complete and accurate information available at the point of presentment.

There are several methods employed by the present state of the art for preventing check fraud. One such method is known as “Validation” in which an inquiry is made into one or more databases to determine whether the check will clear the financial institution based on the history of the checking account. These databases are known as “Positive” or “Negative” databases. A Negative database stores information, usually submitted by merchants and collection agencies, regarding returned checks that have been written by various parties. A Positive database stores information, usually submitted by financial institutions, regarding an account status of a party, sometimes including information such as any “Stop Pays,” account “Open” or “Closed” etc.

The problem with the Validation method is that it does not “validate” the identity of the person presenting the check. Validation only determines the history of the account and whether there have been any “bad” checks written in the past on that particular account. Validation does not determine whether the person presenting the check is actually authorized to write a check on that particular account. Therefore, Validation does not prevent identity theft because a thief with a forged or stolen ID could write a check on someone else's account.

Another prior art solution aimed to prevent check fraud is described in U.S. Pat. Nos. 4,109,238; 4,187,498; 4,672,377; and 5,341,428. These patents describe a document verification system in which a PIN is associated with an identification card that must be presented and verified before the check is accepted. In this method, a person must validate that he/she is the person named on the check by inserting a card into a machine and then entering a PIN associated with that card. While this method may help to validate the identification of the person writing the check, it does not validate that the person writing the check is authorized to write a check on that particular checking account. This is because the PIN is tied with the card and the identity of the person, and not with the particular checking account. Therefore, it would be possible for a person with a “valid” card (whether stolen, fraudulently manufactured, or otherwise) to print fraudulent checks which contain the name of the person as identified on the card, yet a fraudulent or stolen account number. The merchant would simply compare the name on the check with the name on the PIN protected card; however, since the PIN is attached to the card and not to the account, a fraudster could put any account number on the bottom of the fraudulent checks without being detected at the point of presentment.

While these and other methods may help to validate the identification of the person writing the check, they do not validate that the person writing the check is authorized to write a check on that particular checking account. This is because the identification method is tied with the identity of the person, and not with the particular checking account. Therefore, it would be possible for a person with a “valid” identity to print and redeem fraudulent checks without being detected at the point of presentment. Additionally, these and other methods also do not provide for a remote validation of both the check itself and the bearer's identity.

In view of these problems, it is one object of this invention to provide a checking account holder with personal identification information for the checking account, with verification of the personal identification information and checking account information occurring at a remote location.

A further object of the invention is to provide a checking account holder with document identification information for a single check, with verification of the document identification information and checking account information occurring at a remote location.

Another object of the invention is to provide an account holder with a single identifier of personal identification information for multiple financial accounts, wherein the financial account is selected from the group consisting of checking, debit card, and credit card, with verification of the personal identification information and account information occurring at a remote location.

These and other objects will be apparent to those skilled in the art.

### SUMMARY OF THE INVENTION

The present invention is a method of establishing and associating a Personal Identification Number (PIN) to a checking account so that the PIN must be entered by the customer and then validated by the merchant at the point of presentment before the check is accepted by the merchant. The first step in the present invention is for the bank to work with their personal and commercial checking account clients to establish one or more PINs that will be associated with each checking account. The PINs will then be stored in a PIN Database. When a check is written at a point of encashment, whether a retail point of sale or in a teller line at a bank, the check data is entered into the point of sale terminal and transmitted to a Service Provider who has access to the PIN Database. The Service Provider will search the PIN Database which contains tables of American Banker's Association (ABA) numbers and checking account numbers to determine if the account number listed on the check should have a PIN assigned to it. If it does, the point of sale terminal prompts the customer to enter a PIN. The customer then enters a PIN which is transmitted to the Service Provider. The Service Provider (using the PIN Database) then determines whether the entered PIN matches the PIN stored in its database. This validation result is transmitted to the merchant so that the merchant can either accept or reject the check from the customer.

If the Service Provider determines that the check given by the customer does not have a PIN associated with it, that information is given to the merchant so that the merchant can decide whether they want to accept a check from a non-PIN protected checking account.

With the method of the present invention, if a customer enters the valid PIN for a particular checking account, that customer is assumed to be a legitimate user of the account. A secretly protected number is nearly impossible to forge or steal, whereas the identification cards and signatures which are currently used to protect checking accounts are easily forged using today's technology.

### DESCRIPTION OF THE DRAWINGS

FIG. 1 is a schematic diagram illustrating the operating environment for the present invention;

FIG. 2 is a plan view of an individual check according to the present invention;

FIG. 3 is a parallel flow chart illustrating the transfer of information between institutions according to the present invention;

FIG. 4 is a block diagram showing the first embodiment of the present invention where a customer wishes to write a check at a store or bank;

FIG. 5 is a block diagram showing the second embodiment of the present invention where a customer wishes to use a check as a form of payment via a mail order, Internet order, or telephone order;

FIG. 6 is a parallel flow chart illustrating the transfer of information between institutions according to another embodiment of the present invention; and

FIG. 7 is a parallel flow chart illustrating the transfer of information between institutions according to a further embodiment the present invention.

### DETAILED DESCRIPTION OF THE PREFERRED EMBODIMENT

Stated in general terms, the check verification system of the present invention establishes and assigns a secret personal identification information (such as a Personal Identification Number (PIN)) to a checking account, and then requires the entry of the personal identification information when a check from that account is presented to a merchant or bank. The system further verifies that the personal identification information entered by the customer at the point of check presentment is the same as the personal identification information that has been stored in a database for that account number. The personal identification information is to be known only by the account holder and will be stored in a highly secured personal identification information database. The personal identification information may be changed by the account holder or the bank as the need arises. The first step in the present invention is for the bank to establish personal identification information for the checking accounts of their personal and business clients. The respective account number and associated personal identification information are then stored in a personal identification information database which is usually maintained by a third party Service Provider. As an alternative for added security, while the bank assigns checking account information, this information is sent to an independent service provider at a remote location and the personal identification information is assigned by the independent service provider. In the preferred embodiment, the communication between the merchant, Service Provider, and personal identification information database is through an electronic medium such as an Internet connection, which allows participating businesses to electronically communicate with the Service Provider quickly and efficiently.

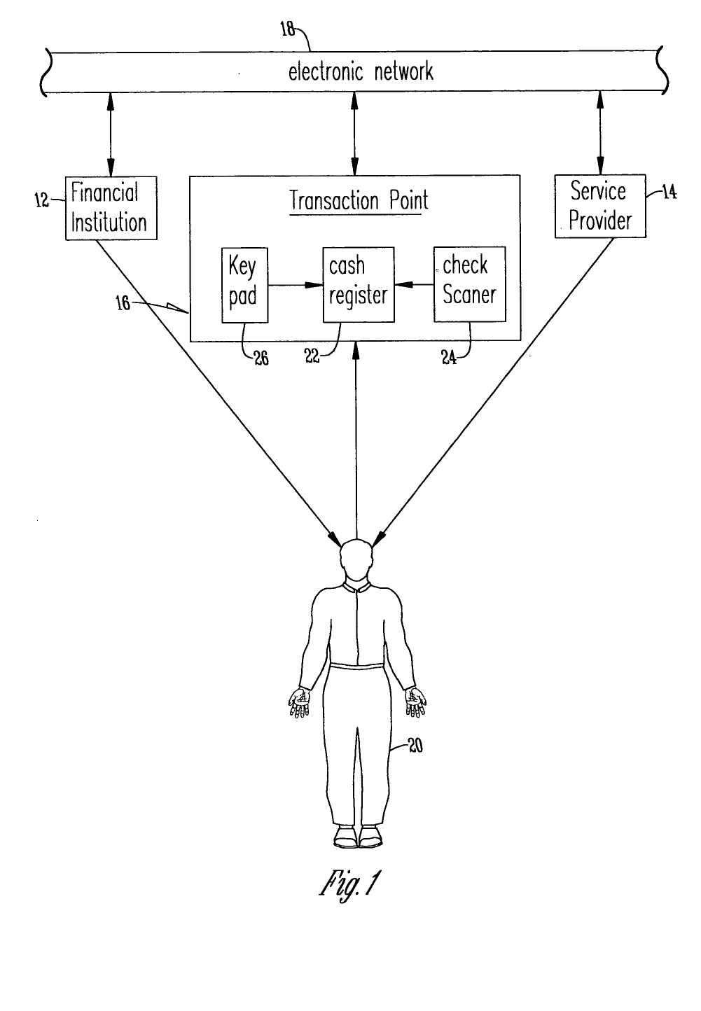

With reference to FIG. 1, a financial institution 12, a remote Service Provider 14, and a transaction point 16 are all connected to an electronic network 18. The electronic network 18 can be a completely wireless network, a completely hard wired network, an analog network, a digital network, or some combination thereof. An account holder 20 interacts with each of the financial institution 12, remote Service Provider 14, and transaction point 16 in the present invention.

As shown, the transaction point 16 has a cash register 22 connected to a check scanner 24 and a keypad 26. Upon presentment of a check by the account holder 20 at the transaction point 16, the check is processed by the check scanner 24 to retrieve some or all of the checking account information for that check. Likewise, the account holder 20 enters personal identification information, such as a confidential personal identification number, into the keypad 26. The checking account information and personal identification information are transmitted from the transaction point 16 at a first location at a second location to the remote Service Provider 14 via the electronic network 18. The remote Service Provider 14 compares the transmitted information with stored checking account information and stored personal identification information for verification, transmits a verification signal from the remote Service Provider 14 back to the transaction point 16. The remote Service Provider 14 may include a processing unit at a second location in electronic communication with the keypad and a check scanner of the transaction point 16 and a memory coupled to the processing unit, wherein the memory contains programming code executed by the processing unit to process the information from the transaction point 16.

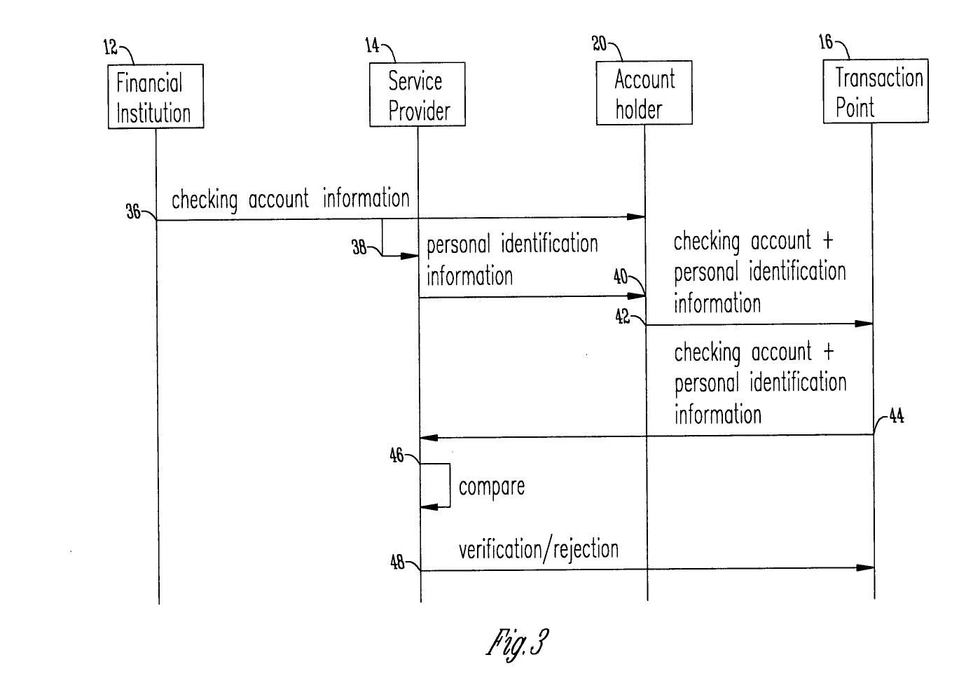

With reference to FIG. 3, in the flow of information between the financial institution 12, remote Service Provider 14, account holder 20 and transaction point 16, checking account information is transmitted from the financial institution 12 to the remote Service Provider 14 and the account holder 20 at step 36 and step 38, respectively. The remote Service Provider 14 then assigns a unique personal identification information such as a confidential personal identification number based on the checking account information, stores an encrypted version of the personal identification information and/or checking account information in a personal identification information database, and transmits this personal identification information to the account holder 20 at step 40. The account holder 20 provides checking account information and personal identification information to the transaction point 16 when using the checking account at step 42. The transaction point 16 transmits the checking account information and personal identification information to the remote Service Provider 14 at step 44. The remote Service Provider 14 compares the transmitted information with stored checking account information and stored personal identification information for verification at step 46, and transmits a verification signal from the remote Service Provider 14 back to the transaction point 16 at step 48 indicating either acceptance or rejection of the transaction.

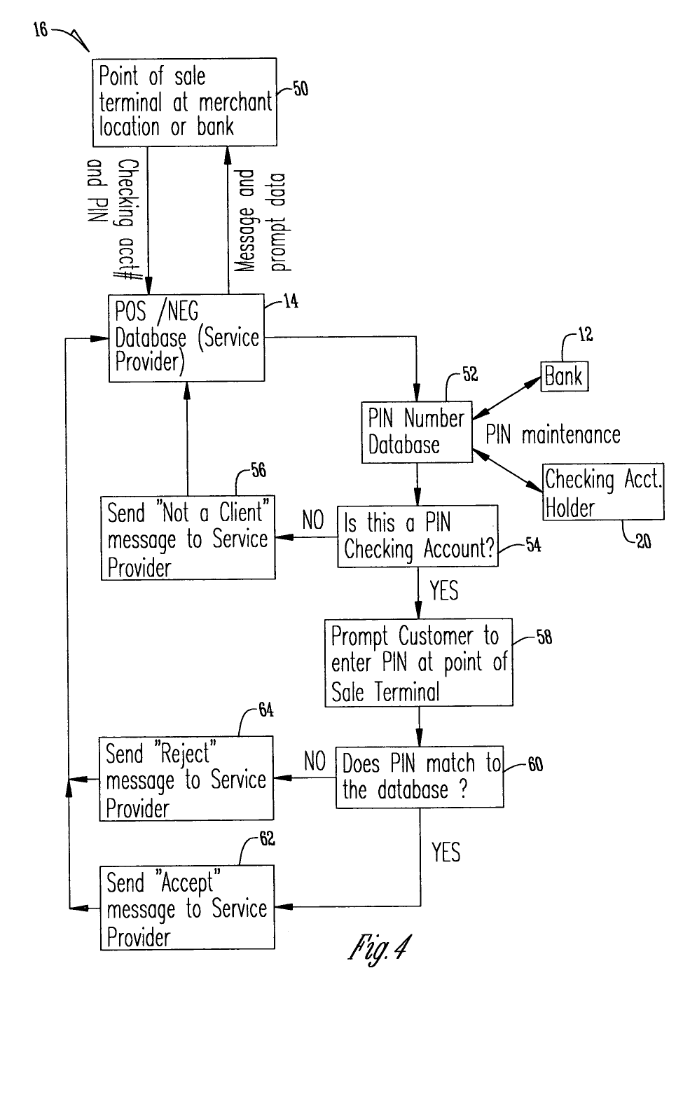

FIG. 4 shows a block diagram of how the method of the present invention is employed when a customer writes a check at a point of sale terminal 50 at a transaction point 16. A customer enters a merchant store or bank with the desire to write a check for cash or to make a purchase of goods. The customer writes the check and gives it to the cashier, who then enters the checking account information (electronic check data such as the bank routing number and account number) into the point of sale terminal 50. In the preferred embodiment, the merchant does not have direct contact with the personal identification information database 52; rather the merchant has access to the personal identification information database through a third party Service Provider 14, as shown in FIG. 4.

The Service Provider 14 can offer the merchant a range of services beyond providing the merchant with information on the checking account's personal identification information. For example, the Service Provider 14 can transmit information on the checking account's history, such as the Positive and Negative Data as discussed in the “Background of the Invention” section of this specification. These Positive and/or Negative Databases provide the merchant with quick information regarding whether the checking account has recently had good or bad transactions. For example, these databases can provide the merchant with information as to whether a check has recently been denied because incorrect personal identification information was given by a customer on that checking account. If incorrect personal identification information has been given a number of times in the recent history of the checking account, the cashier may wish to advise security personal in addition to not accepting the check. Additionally, where the check is a payroll check, these Positive and/or Negative databases can provide the merchant with information as to whether the payroll check contradicts known payroll frequency data and maximum payroll payment amount data.

Regardless of whether the merchant chooses to receive account history data, the Service Provider 14 uses the checking account information (electronic check information) transmitted by the merchant to search the personal identification information database to determine whether the checking account being presented has personal identification information associated therewith that should be verified by the merchant. The preferred embodiment of the present invention includes additional methods for alerting the merchant that the check is protected by personal identification information. These additional methods should be used in addition to contacting the personal identification information database to determine whether an account is PIN protected.

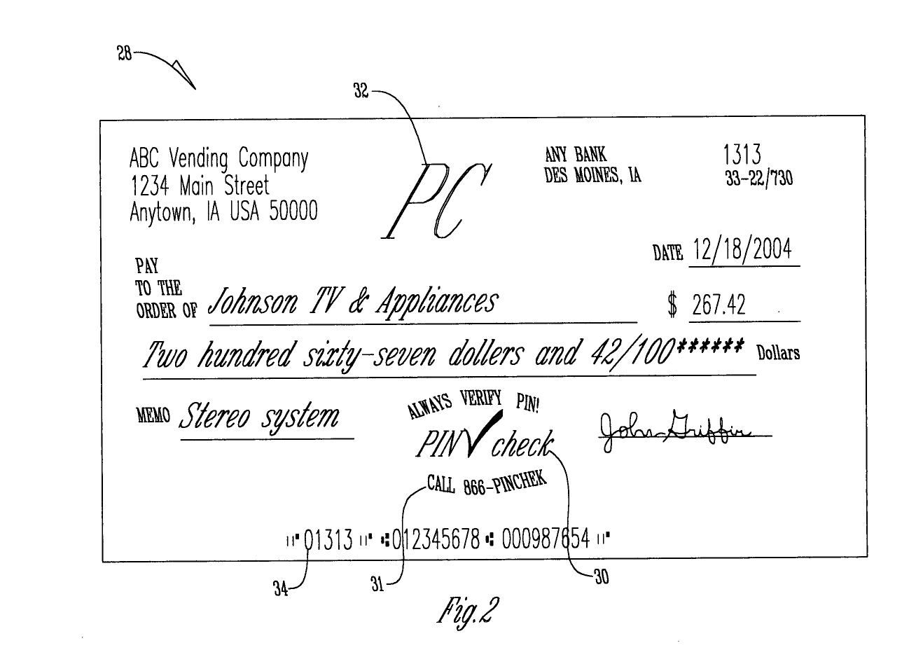

With reference to FIG. 2, the preferred embodiment of the present invention includes additional methods for alerting the merchant that the check 28 is protected. These additional methods in addition to contacting the remote Service Provider 14 database indicate that an account is protected by the remote Service Provider 14. One additional method includes the check having a distinct symbol 30, indicia, or feature on its face to alert the merchant that personal identification information is required to be verified before the check 28 can be accepted. This symbol 30 may include a phone number 31 for contacting the remote Service Provider 14, or for a watermark, symbol or hologram (hereinafter watermark 32) to be embedded within the paper of the check 28. Yet another additional method involves having the account number 34 begin with a distinct letter or number. This will help combat forgery because regardless of what the forger does to the face of the check 28, the forger would have to keep the same account number on the check 28 in order for money to withdrawn from that particular account, and therefore even if a forger removed the distinct symbol from the check 28 the cashier would still be put on notice that the check 28 should be verified by personal identification information.

At decision block 54 of FIG. 4, if the personal identification information database 52 finds that the account does not have an associated personal identification information, the Service Provider 14 sends a “not a client” message at block 56 that is relayed to the Point of Sale Terminal 50 so that the merchant can decide whether or not they wish to proceed with the transaction knowing the checking account being used is not protected by personal identification information. At decision block 54, if the personal identification information database 52 finds that the particular account does have personal identification information associated with it, then the Service Provider 14 prompts the customer to enter his/her personal identification information at the Point of Sale Terminal 50, at block 58. If the Service Provider 14 determines that the personal identification information entered by the customer matches the stored personal identification information in the personal identification information database at step 60, then an “Accept” message is sent to the Point of Sale Terminal 50 at step 62, along with positive feedback to the Positive Database for that account. If the personal identification information entered by the customer does not match the stored personal identification information in the personal identification information database at step 60, then a “Reject” message is sent to the Point of Sale terminal 50 along with negative feedback to the Negative Database for that account at step 64.

In an alternative to the first embodiment described in FIG. 4 where the merchant is not a subscriber to the checking personal identification information system, or does not have adequate Point of Sale Terminal 50 technology to receive the proper information via an electronic medium, the merchant can call the Service Provider 14 and verify the personal identification information for the account over the phone so that the customer is still protected. In this embodiment, an automated integrated voice system is provided for processing the transmitted information, where at least a portion of the communications with the integrated voice system is communicated as voice signals.

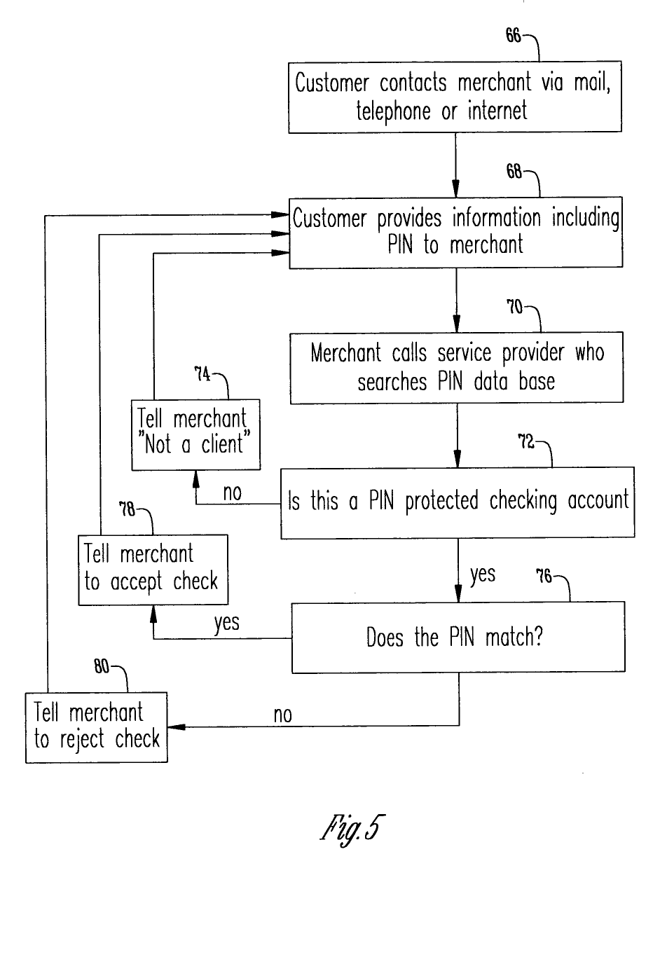

In the second embodiment of the present invention the customer does not enter the merchant's store personally, rather the merchant accepts orders and checks from customers over the phone, through the mail, or via the Internet. FIG. 5 shows a block diagram of a second embodiment of the present invention. In this embodiment, after the customer contacts the merchant at step 66, the customer must provide the personal identification information assigned to the checking account through the respective contact medium at step 68. In the preferred embodiment, the customer must also provide the merchant with certain personal information, such as a mother's maiden name or the customer's social security number. The merchant can either ask the customer for the checking account number and manually enter it into a Point of Sale Terminal (not shown) as described in the previous embodiment, or the merchant can verify the personal identification information by calling a Service Provider (not shown) on the phone to verify that the personal identification information is correct at step 70. Once the merchant calls the Service Provider, the method is similar to the first embodiment. The third party Service Provider can tell the merchant whether the customer's checking account is protected by personal identification information, determined at decision block 72, as well as other Positive or Negative data relating to the account. If the account is not protected by personal identification information the Service Provider alerts the merchant at step 74, and the merchant can decide whether they wish to accept a check from a non-personal identification information protected account. If the checking account is protected by a PIN the Service Provider proceeds to step 76, where the merchant can communicate with the third party Service Provider personal identification information database to determine whether the personal identification information given by the customer matches the stored personal identification information in the database. Positive and negative feedback can also be given into the Positive Database or Negative Database by the third party Service Provider database if such action is desired. If the personal identification information given by the customer matches the stored personal identification information in the database, the Service Provider proceeds to step 78 to inform the merchant to accept the check. If the personal identification information given by the customer does not match the stored personal identification information in the database, the Service Provider proceeds to step 80 to inform the merchant to reject the check.

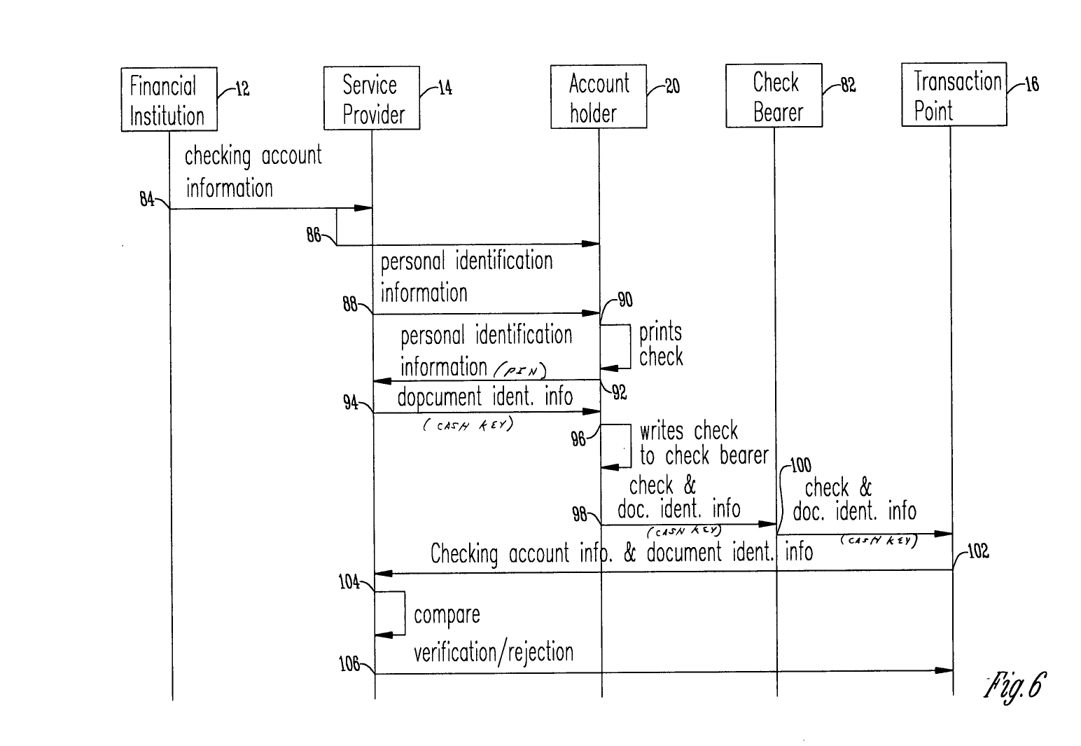

With reference to FIG. 6, in the third embodiment of the present invention a checking account holder is provided with document identification information for a single check, with verification of the document identification information and checking account information occurring at a remote location. Specifically, in the flow of information between the financial institution 12, remote Service Provider 14, account holder 20, third party 82 and transaction point 16, checking account information is transmitted from the financial institution 12 to the remote Service Provider 14 and the account holder 20 at step 84 and step 86, respectively. The remote Service Provider 14 then assigns a unique personal identification information such as a confidential personal identification number based on the checking account information, stores an encrypted version of the personal identification information and/or checking account information in a personal identification information database, and transmits this personal identification information to the account holder 20 at step 88. The account holder 20 then obtains a check including checking account information at step 90. One method of obtaining the check is for the account holder 20 to print the check on a personal computing device (not shown). The account holder 20 then contacts the Service Provider 14 and supplies personal identification information of the account holder 20 along with information for a given single check to the Service Provider 14 at step 92. The Service Provider 14 assigns a unique single identifier of document identification information such as a confidential document identification number (CASH KEY) for the given single check, stores an encrypted version of the document identification information in the database, and transmits this document identification information to the account holder 20 at step 94. The account holder 20 writes the single check to a check bearer 82 at step 96, and provides the check bearer 82 the single identifier of document identification information (CASH KEY) associated with the given single check at step 98. The check bearer 82 provides the checking account information and document identification information from the given single check to the transaction point 16 at step 100. The transaction point 16 transmits the checking account information and document identification information to the remote Service Provider 14 at step 102. The remote Service Provider 14 compares the transmitted information with stored checking account information and stored document identification information for verification at step 104, and transmits a verification or rejection signal from the remote Service Provider 14 back to the transaction point 16 at step 106.

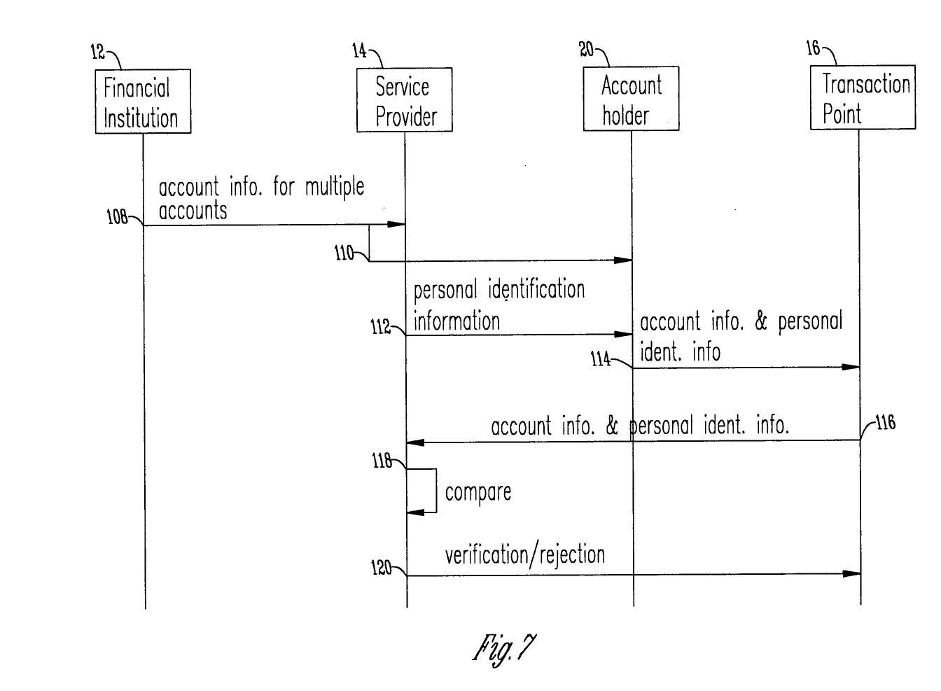

With reference to FIG. 7, in the fourth embodiment of the present invention a checking account holder is provided with a unique single identifier of personal identification information for multiple financial accounts, wherein the financial account includes but is not limited to the following account types: checking, debit card, and credit card, with verification of the personal identification information and account information occurring at a remote location. Specifically, in the flow of information between the financial institution 12, remote Service Provider 14, account holder 20 and transaction point 16, account information for multiple financial accounts is transmitted from the financial institution 12 to the remote Service Provider 14 and the account holder 20 at step 108 and step 110, respectively. The remote Service Provider 14 then assigns a unique single identifier of personal identification information for the multiple financial accounts such as a confidential personal identification number based on the account information, stores an encrypted version of the personal identification information and/or account information in a personal identification information database, and transmits this personal identification information to the account holder 20 at step 112. The account holder 20 provides account information from a select account of the multiple financial accounts and personal identification information to the transaction point 16 at step 114. The transaction point 16 transmits the account information from the select financial account and personal identification information to the remote Service Provider 14 at step 116. The remote Service Provider 14 compares the transmitted information with stored account information and stored personal identification information for verification at step 118, and transmits a verification or rejection signal from the remote Service Provider 14 back to the transaction point 16 at step 120.

It is an important feature of all embodiments of this invention that one checking account can be given several different PINs. This feature is especially important in the instance where a business wants to have several different people authorized to write checks on one account. If each person receives one unique and secret PIN, then the business can later determine who wrote what check by determining which PIN was used to validate the check. This can be done regardless of what signature was on the check, since signatures can easily be forged. Furthermore, if an employee is authorized on an account and is subsequently fired or otherwise should no longer be authorized to use the checking account, this employee's PIN can simply be removed from the list of authorized PINs in the database. The current state of the art does not protect a business when an employee is fired because the present state of the art only determines a person's identification, not whether that person is authorized to write a check on a particular account. Therefore, a fraudster or disgruntled employee could retain or forge identification that would allow him/her to write checks from the company's account without the company's authorization.

Whereas the invention has been shown and described in connection with the embodiments thereof, it will be understood that many modifications, substitutions, and additions may be made which are within the intended broad scope of the following claims. From the foregoing, it can be seen that the present invention accomplishes at least all of the stated objectives.

1. A method for preventing check fraud, the method comprising the steps of:
establishing personal identification access information for a checking account from a financial institution;
transmitting the checking account information and the personal identification access information from a first location to a second location;
comparing the transmitted information with stored checking account information and stored personal identification access information at the second location for verification; and
transmitting a verification signal from the second location to the first location.

2. The method of claim 1, further comprising the step of: providing the personal identification access information as a confidential personal identification number.

3. The method of claim 2, further comprising the step of: providing multiple personal identification numbers for a single checking account, with at least one personal identification number for each authorized signatory on the checking account.

4. The method of claim 1, further comprising the step of: providing an automated integrated voice response system for processing the transmitted information, where at least a portion of communications with the integrated voice response system are communicated as voice signals.

5. The method of claim 4, further comprising the step of: providing an indicia on the check, wherein the indicia assists a user in connecting with the integrated voice response system.

6. The method of claim 1, further comprising the step of: encrypting the stored information.

7. The method of claim 1, further comprising the step of: providing an indicia on the check as an indication of authenticity.

8. The method of claim 1, further comprising the step of: comparing the transmitted information with stored checking account information at the second location for verification, wherein the stored checking account information includes data on payroll frequency and maximum payroll payment amounts where the check is a payroll check.

9. A method for preventing check fraud, the method comprising the steps of:
providing a document with document identification information;
transmitting document information and document identification information from a first location to a second location;
comparing the transmitted information with stored document information and stored document identification information at the second location for verification; and
transmitting a verification signal from the second location to the first location.

10. The method of claim 9, further comprising the step of: providing the document identification information as a confidential document identification number.

11. The method of claim 9, further comprising the step of: a document holder supplying personal identification information to the second location to obtain the document identification information from the second location.

12. The method of claim 11, further comprising the step of: the document holder printing the document from a personal computing device.

13. The method of claim 9, further comprising the step of: the document holder writing the document to a check bearer and providing the check bearer the document identification information associated with the document.

14. The method of claim 13, further comprising the step of: the document bearer providing the document information and document identification information from the document at the first location.

15. A method for preventing check fraud, the method comprising the steps of:
establishing personal identification access information for a checking account from a financial institution;
associating the single personal identification access information with account information from multiple financial accounts;
transmitting account information and the personal identification access information from a first location to a second location;
comparing the transmitted information with stored account information and stored personal identification access information at the second location for verification; and
transmitting a verification signal from the second location to the first location.

16. The method of claim 15, wherein the financial account is selected from the group consisting of checking, debit card, and credit card.

17. The method of claim 15, further comprising the step of: providing the personal identification access information as a confidential personal identification number.

18. An apparatus for preventing check fraud for use with a transaction point at a first location, the transaction point having a keypad and a check scanner, the apparatus comprising:
a processing unit at a second location in electronic communication with the keypad and a check scanner; and
a memory coupled to the processing unit, wherein the memory contains programming code executed by the processing unit to:
receive keypad and a check scanner data including checking account information and personal identification access information established from a financial institution from the transaction point;
compare the transmitted keypad and a check scanner data information with stored checking account information and stored personal identification access information at the second location for verification; and
transmit a verification signal from the second location to the first location.

19. The apparatus claim of claim 18, wherein the memory contains programming code executed by the processing unit to:
provide the personal identification access code as a confidential personal identification number.

20. The apparatus claim of claim 18, wherein the memory contains programming code executed by the processing unit to: provide multiple personal identification access codes for a single checking account, with at least one personal identification access code for each authorized signatory on the checking account.

21. The apparatus claim of claim 18, wherein the memory contains programming code executed by the processing unit to: provide an automated integrated voice response system for processing the transmitted information, where at least a portion of communications with the integrated voice system are communicated as voice signals.

22. The apparatus claim of claim 18, wherein the memory contains programming code executed by the processing unit to: encrypt the stored information.

23. The apparatus claim of claim 18, wherein the memory contains programming code executed by the processing unit to: compare the transmitted information with stored checking account information at the second location for verification, wherein the stored checking account information includes data on payroll frequency and maximum payroll payment amounts where the check is a payroll check.

24. A method for preventing check fraud, the method comprising the steps of:
providing an indicia on a check as an indication of authenticity;
associating a confidential personal identification number with checking account information;
transmitting checking account information and the confidential personal identification number from a first location to a second location;
comparing the transmitted information with stored checking account information and stored confidential personal identification number at the second location for verification;
wherein the stored information is encrypted;
providing an automated integrated voice response system for processing the transmitted information, where at least a portion of communications with the integrated voice system are communicated as voice signals; and
transmitting a verification signal from the second location to the first location.

25. The method of claim 24, further comprising the step of: providing multiple personal identification numbers for a single checking account, with at least one personal identification number for each authorized signatory on the checking account.

26. The method of claim 24, further comprising the step of: providing an indicia on the check, wherein the indicia assists a user in connecting with the integrated voice response system.

27. The method of claim 24, further comprising the step of: comparing the transmitted information with stored checking account information at the second location for verification, wherein the stored checking account information includes data on payroll frequency and maximum payroll payment amounts where the check is a payroll check.
